(19) United States
(12) Patent Application Publication
(10) Pub. No.: US 2022/0144123 A1
(43) Pub. Date: May 12, 2022

(54) METHOD FOR OPERATING A BOOKING SYSTEM OF A CHARGING STATION FOR AN ELECTRIC VEHICLE

(71) Applicant: Volkswagen Aktiengesellschaft, Wolfsburg (DE)

(72) Inventors: Torsten STICHOWSKI, Magdeburg (DE); Dimitri SCHREINER, Braunschweig (DE); Andreas LANGE, Braunschweig (DE); Carmen KRUMM, Berlin (DE); Adrian SASSE, Braunschweig (DE)

(73) Assignee: Volkswagen Aktiengesellschaft, Wolfsburg (DE)

(21) Appl. No.: 17/581,362

(22) Filed: Jan. 21, 2022

Related U.S. Application Data
(63) Continuation of application No. PCT/EP2020/068954, filed on Jul. 6, 2020.

(30) Foreign Application Priority Data
Jul. 22, 2019 (DE) 10 2019 210 848.2

(51) Int. Cl. B60L 53/66; B60L 53/62; B60L 53/30; G06Q 10/02

(52) U.S. Cl. CPC B60L 53/665; G06Q 10/02; B60L 53/305; B60L 53/62

(57) ABSTRACT

A method for operating a booking system of a charging station for an electric vehicle. In the method of the invention, first a blocking message for a first charging station is received from a user. Subsequently, a current distance between the user and the first charging station, a current charging state of the first charging station, and a current booking entry of the first charging station are determined. In the method of the invention, further the blocking message is discarded or further processed depending on the determined distance, the determined charging state, and the determined booking entry. A further aspect of the present invention relates to a network server for carrying out the method.

This nonprovisional application is a continuation of International Application No. PCT/EP2020/068954, which was filed on Jul. 6, 2020, and which claims priority to German Patent Application No. 10 2019 210 848.2, which was filed in Germany on Jul. 22, 2019, and which are both herein incorporated by reference.

### BACKGROUND OF THE INVENTION

### Field of the Invention

The present invention relates to a method for operating a booking system of a charging station for an electric vehicle, in particular to a method of a network server for operating a booking system of this kind. The invention relates further to a network server that is configured to carry out the method of the invention.

### Description of the Background Art

Electric vehicles still have a shorter range compared to conventional vehicles with combustion engines. The power required to recharge the electric power at a charging column is also significantly greater than the time required to refuel with gasoline or diesel. For this reason, reliable planning of charging processes is of great importance for users of electric vehicles.

It is therefore already known from the prior art to use booking or reservation systems for charging columns or charging stations for an electric vehicle in order to coordinate the charging processes of a large number of users.

For example, US 2013/0151293 A1 describes a method for coordinating reservations for an electric charging column, according to which, in response to a booking request received from a first user, a time slot corresponding to the request is booked for the first user. At least for a first part of the time slot, the supplying of power is blocked for other users who are not the first user.

In principle, such booking systems are indeed suitable for increasing the probability that a planned charging process will actually be carried out. In practice, however, it can happen that the booked charging column is blocked, for example, by another vehicle, and therefore the planned charging process cannot be carried out.

U.S. Pat. No. 10,169,783 B2 likewise describes a reservation system for a charging station in which a user who has booked a time slot for a charging process and has paid in advance receives authentication information in order to be able to start the charging process. According to a preferred embodiment, location information from vehicles is used further to determine available or already occupied charging stations in the vicinity.

In principle, this method does enable a user to be informed in advance about the occupancy of the charging column, but it can still happen that a user cannot use a prepaid booking at the charging column. This is a clear disadvantage of known booking systems, which is detrimental to the acceptance of electric vehicles.

U.S. Pat. No. 10,217,160 B2 describes a method for providing payment options for a user of an electric charging column. According to a preferred embodiment, a parking spot belonging to a charging station is blocked if the charging column is booked by a user. This should be done, for example, by mechanical barriers. Equipping charging columns in this way is expensive, however, and may not be permitted.

In order to increase the acceptance of electric vehicles, therefore, users should at least be given a compensation option if a paid booking cannot be fulfilled. This can be done, for example, by users reporting a blocking of the charging station and being reimbursed for the booking costs in response.

No reliable and automated method is known from the prior art for a user to report a blocking of a charging column. In principle, there is of course the possibility of taking a photo of the situation in the vicinity and sending it to a customer service. Further, a small number of existing charging columns are equipped with sensor systems that are to enable the detection of blocking in the vicinity of the charging station.

However, the solutions known from the prior art for reporting blocking of a booked charging station are disadvantageous for various reasons. Thus, taking a photo of the blocking is already problematic for reasons of data protection. Further, it is difficult to automate the analysis of a photo to assess whether a blocking of a charging column actually exists. The use of additional sensors in the charging column is basically suitable for detecting a blocking, but is associated with additional costs and is susceptible to faults and vandalism.

### SUMMARY OF THE INVENTION

It is therefore an object of the present invention to provide an automated method for detecting and reporting blocking of a charging column in connection with the booking and reserving of charging columns.

An aspect of the present invention relates to a method for operating a booking system of a charging station for an electric vehicle. The method of the invention is preferably carried out by a network server. The network server is preferably a backend server of an operator of the charging station.

The network server is preferably designed to communicate with the plurality of charging stations and to operate a booking system for the plurality of charging stations. In the context of the present application, a booking system is understood in the broadest sense to mean that a user can book a specific charging station in advance for a specific period of time. Charging at the charging station is then possible within the booked period, at least in a first period thereof, only for the user who made the booking. The booking system is also preferably designed to complete the payment for the charging process. It can be provided in this case that a booking fee is to be paid before booking. The costs of the actually drawn electrical power can also be paid in advance or after the actual charging process. The booking system is designed, for example, as a database system located on the network server. Different users communicate preferably with the network server via a wireless interface of their vehicle or mobile device and are authorized to make bookings, if necessary, after registering on the network server. Booking systems for charging stations are known in principle to the skilled artisan from the prior art.

In a first step of the method of the invention, a blocking message for a first charging station is received from a user. The first charging station is preferably one of a plurality of charging stations. The blocking message is preferably contained in a message received via a wireless interface. The blocking message contains at least the information that the user is reporting a blocking, therefore, the impossibility of carrying out a charging process at the charging station, for the first charging station at a certain first point in time. In addition, the blocking message has further information on the identity of the user and on a unique identifier for the first charging station. The blocking message received from the user is temporarily stored by the network server, for example, in a memory of a communication module. The further processing of the blocking message in the method of the invention depends on a number of additional factors, as will be explained in detail below.

In the method of the invention, a current distance between the user and the first charging station is determined in response to the receipt of the blocking message. The information required for this is preferably already contained in the blocking message or is obtained from the network server in response to the receipt of the blocking message. The information is preferably obtained from the user or the first charging station. The current distance between the user and the first charging station thus designates a distance shortly before, at, or shortly after the time the blocking message was received. The current distance preferably denotes the distance in a time window of ±30 or likewise preferably of ±1 s, ±5 s, ±10 s around the time when the blocking message was received.

In the method of the invention, further a current charging state of the first charging station is determined in response to the receipt of the blocking message. In so doing, the charging station indicates whether a vehicle is currently connected to the first charging station and/or whether electrical power is being drawn by the vehicle. The information necessary for this is preferably already contained in the blocking message or is obtained from the network server in response to the receipt of the blocking message. The information is preferably obtained from the user or the first charging station. The current charging state thus designates a charging state shortly before, at, or shortly after the time the blocking message was received. The current charging state preferably relates to a time window of ±30 or of ±1 s, ±5 s, ±10 s around the time when the blocking message was received.

In the method of the invention, further a current booking entry of the first charging station is determined in response to the receipt of the blocking message. The booking entry in this case indicates whether and for whom a reservation for the first charging station is stored in the booking system at the time the blocking message was received. For this query, the network server only needs the time of receipt of the blocking message, possibly including a time window around this time, for example, of ±30 or of ±1 s, ±5 s, or ±10 s. The booking system is particularly preferably operated by the network server itself, so that it can access the booking information immediately. Alternatively, the blocking message and the booking system are operated by different servers or server components that communicate with one another. In this case, the booking information is retrieved.

In the method of the invention, finally the blocking message is discarded or further processed depending on the distance, the charging state, and the booking entry. Thus, in the method of the invention, various signals are evaluated which, in a causal context, provide a reliable indication of whether or not a charging process is possible at the charging column at the current point in time. In this way, a blocking message received from a user can advantageously be verified and further processed or else falsified and discarded. Because the blocking message can result in a reimbursement of costs, misuse and losses by the operator are thus prevented.

The blocking message can be received from a vehicle or from a mobile device of the user. An application can be installed in the vehicle, for example, in the infotainment system of the same, or on the mobile device; the application enables the user to transmit a blocking message for a specific charging station to the network server. If the user approaches a blocked charging station with his electric vehicle, he can thus simply submit a blocking message. In this regard, in the method of the invention the position of the mobile device or the vehicle is the same as the current position of the user. Likewise preferably, the user is uniquely identified on the basis of a vehicle identification information contained in the blocking message, for example, the license plate number or vehicle identification number, or of the mobile device.

A current position of the vehicle or mobile device can be received in the method of the invention. This information is preferably already contained in the blocking message or is obtained by the network server in response to the blocking message from the network server, therefore, is retrieved from the vehicle or the mobile device. It is conceivable in this case that the blocking message is retrieved from the user's mobile device, whereas the position is retrieved from the vehicle. This ensures that the vehicle is actually close to the charging station and that a charging process was thus actually planned and desired by the user. On the basis of the position received from the vehicle or the mobile device, the distance between the user and the charging station is then determined in the method of the invention, preferably by the network server. The distance is also preferably determined directly in the vehicle or mobile device and transmitted to the network server. Almost without exception, modern vehicles and mobile devices have a GPS transceiver and thus the position data can be acquired particularly easily and precisely according to this embodiment.

When the distance between the user and the first charging station is determined, further the fixed position of the first charging station is used. This is preferably stored in the network server and is determined by it on the basis of identification information of the first charging column received with the blocking message, for example, retrieved from a memory. Alternatively, the position information of the charging station is preferably stored in it and is transmitted from it to the user's vehicle or mobile device, for example, via near-field communication. The identification information of the charging station also preferably includes its geographical coordinates.

Also, in the method of the invention the distance between the user and the charging station can be received as the distance between the vehicle and the charging station. In this regard, the distance from the vehicle is received and is based on measurement data from at least one first sensor, in particular a distance sensor of the vehicle. Modern vehicles usually have distance sensors, such as, for example, LIDAR or ultrasound, so that this embodiment is also easy to implement. The distance data are also preferably determined by the charging station, for example, using sensors built into the charging station or using a signal from a connection between the charging station and the user's vehicle or mobile device (ToF, ToA, etc.).

In the method of the invention, the current charging state of the charging station can be determined on the basis of a current connector status or on the basis of a current power delivery by the charging column. The connector status indicates whether the charging connector of the charging station is currently plugged into a charging port of a vehicle. This is preferably detected by a sensor built into the connector, for example, a pressure sensor or pressure switch. Alternatively, or in addition, a current supplying of power by the charging station is determined. Because a blocking of a charging station can be caused in particular by a vehicle that was previously charged at the station and has ended the charging process but has not been removed from the charging station, it is preferred to determine the charging status on the basis of the connector status. The information is usually available in the charging station itself and is transmitted by it to the network server. This information is also preferably transmitted from the charging station to the user's vehicle or mobile device via near-field communication, for example, Bluetooth, and passed on from there to the network server.

In the method of the invention, the blocking message is finally discarded, i.e., deleted by the network server or excluded from further processing, provided that the determined distance between the user and the first charging station exceeds a predetermined distance if the determined charging state of the first charging station indicates the charging, or a current charging process, of a second vehicle at the first charging station, or if the booking entry determined on the basis of the blocking information does not correspond to the user. A current charging process is also understood here to mean that the connector of the charging station is plugged into the second vehicle but no more electrical power is being obtained by the second vehicle (completed charging process with a still connected connector). In other words, only one of the aforementioned conditions need not be met for the blocking message to be rejected.

In the method of the invention, the blocking message can be processed further, therefore, not discarded, if the determined distance between the user and the first charging station falls below a predetermined distance, if the determined charging state of the first charging station does not indicate any charging process of a second vehicle at the first charging station, and if the booking entry determined on the basis of the blocking information corresponds to the user. A current charging process is also understood here to mean that the connector of the charging station is plugged into the second vehicle but no more electrical power is being obtained by the second vehicle (completed charging process with a still connected connector). In other words, all of the aforementioned conditions must be met cumulatively for the further processing of the blocking message.

As already set forth, in the method of the invention, various signals are evaluated which together provide a reliable indication of whether or not a charging process is possible at the charging column at the current point in time. The source of this information is the vehicle, a mobile device with a corresponding app, a combination of both, or, if applicable, the first charging station itself. According to the invention, in particular, the signals, i.e., charging state, distance or position, as well as time or booking entry, are provided or determined.

The comparison of the position of the user with the position of the charging station carried out in the method of the invention enables a check as to whether the charging station was reached at all or was in the vicinity of the user at the time of the blocking message. A fraudulent blocking message from a greater distance, for example, to conceal a delay that precludes compensation, is thus prevented.

If the blocking is reported from a sufficiently short distance, it is relevant further whether the first charging station is currently occupied by a second vehicle. If this is the case, the charging station is initially detected as being occupied and not as blocked, so that then blocking of the charging station also cannot initially be claimed. In this case, it must be checked further whether only the connector is plugged into the second vehicle or whether power is actually being supplied to the second vehicle. At least in the case of power being actually supplied, a permissible use of the first charging station and thus not a blocking of the same by the second vehicle may be assumed. Alternatively, if it is discovered that the occupancy of the column is within the booking period and the registered user does not correspond to the booking user, there may be an error in the booking system but not a blocking in the strict sense. If, in contrast, only the connector is plugged in, the charging station may be blocked by the previously charging user. Either way, in the method of the invention, a blocking of the charging station is determined in the event that no charging process is taking place at the time of the blocking message, and taking into account the further information on the booking entry and the distance.

In the method of the invention, the determination of a blocking of the charging station preferably may only apply subject to the further course of time. In a preferred embodiment of the method of the invention, a user's charging process is determined further within a time window corresponding to the determined booking entry. In particular, the charging process is carried out after the above-mentioned steps of the method of the invention have been carried out, preferably as part of the further processing of the blocking message.

According to this embodiment, the blocking message is further processed in the booking system for a partial reimbursement of booking fees in response to the determination of the user's charging process within the time window corresponding to the determined booking entry. In other words, if the customer can reconnect the connector a short time later and then start the charging process, a temporary blocking is assumed, in which there is a claim for partial reimbursement of the booking costs.

After the above-mentioned steps have been carried out, in particular after a blocking has been determined, no charging process by the user is determined within a time window corresponding to the determined booking entry. In other words, the user cannot plug in the connector of the charging station for the entire booked period and may even move away from the charging station. In this case, the blocking message will be processed further in the booking system for a full reimbursement of booking fees. In other words, a complete blocking is assumed in which there may be a claim for full reimbursement of the user's booking costs.

The user further has the option to comment on the incident, for example, by adding a text message to the blocking message. This may have the advantage that additional information for evaluating the blocking situation can be acquired.

A further aspect of the invention relates to a vehicle, in particular a passenger vehicle with an internal combustion, electric, or hybrid engine, configured to carry out the steps of a vehicle in the method of the invention. The vehicle has a first sensor configured to detect ambient data and a communication module configured to communicate with a network server and a charging station.

The at least one first sensor is designed to detect sensor signals relating to the vehicle's surroundings. An ambient signal received by means of the at least one first sensor preferably enables the vehicle to obtain information about its surroundings and preferably represents a wide variety of ambient information. The first sensor is, for example, an imaging sensor such as cameras, a distance sensor such as LIDAR, and/or a GPS sensor or the like.

The first communication module is preferably configured to communicate with other devices, such as, for example, GPS satellites or a smart infrastructure. The first communication module preferably has a radio, cellular, WLAN, and/or Bluetooth transceiver or alternative wireless communication devices. The vehicle further has an electrical driving system with an electrical energy storage device, in particular a battery system, wherein the latter can be charged via a charging port.

The vehicle further has a first control unit which is configured to communicate with the at least one first sensor and with the first communication module. The control unit is configured further to carry out the steps of the vehicle in the method of the invention or to instruct the other components of the vehicle to carry out the steps of the method of the invention.

The first control unit is designed, in particular, to acquire a user input and, in response to the user input, to transmit a blocking message for a first charging station to a network server. The control unit is preferably designed to determine a position of the vehicle and/or a distance to the first charging station and to transmit these to the network server together with or in addition to the blocking message. The control unit is preferably designed to receive information on a geographic position of the first charging station, identification information of the first charging station, and/or information on a charging state of the first charging station from the first charging station and to forward these to the network server. The control unit is preferably designed to transmit identification information of the vehicle to the network server.

A further aspect of the invention relates to a method of a control unit of a vehicle, which has at least one first sensor configured to acquire ambient data, at least one second sensor configured to acquire vehicle status data, and a communication module as well as the control unit, wherein the method comprises at least the following steps: detecting a user input and transmitting a blocking message for a first charging station to a network server in response to the user input, preferably determining a position of the vehicle and/or a distance to the first charging station and transmitting the position and/or the distance together with or in addition to the blocking message to the network server, preferably receiving information on a geographic position, identification information, and/or information on a charging state from the first charging station, and likewise preferably forwarding the received information to the network server.

A further aspect of the present invention relates to a network server, for example, a network server of an operator of charging stations for electric vehicles or of a service partner. The network server of the invention has a second communication module, configured for data communication with a plurality of charging stations as well as vehicles and/or mobile devices, and a second control unit. In this regard, the second control unit of the network server is configured to carry out the method of the invention. The second control unit is designed, in particular, to control the second communication module to receive a blocking message for a first charging station from a user, to determine a current distance between the user and the first charging station, to determine a current charging state of the first charging station, and to determine a current booking entry for the first charging station, and is configured further to discard or further process the received blocking message depending on the distance, the charging state, and the booking entry.

A further aspect of the present invention relates to a system comprising a network server of the invention, as described above, and a vehicle, as described above. All method steps and aspects of the method of the invention can advantageously be implemented in the system of the invention. The system of the invention also preferably further comprises a mobile device, in particular a smartphone or the like. The mobile device preferably has a third communication module configured for communication with the network server and, if necessary, the vehicle. The mobile device further has a third control unit which is designed to carry out the steps of the mobile device in the method of the invention. The third control unit is preferably designed to acquire a user input and, in response to the user input, to transmit a blocking message for a first charging station to a network server. The control unit is preferably designed to determine a position of the mobile device and/or a distance to the first charging station and to transmit these to the network server together with or in addition to the blocking message. The control unit is preferably designed to receive information on a geographic position of the first charging station, identification information of the first charging station, and/or information on a charging state of the first charging station from the first charging station and to forward these to the network server. The control unit is preferably designed to transmit identification information of the mobile device to the network server.

A further aspect of the invention relates to a computer program comprising commands which, when the program is executed by a computer, such as, for example, a control unit of a vehicle, cause the computer to carry out the steps of the vehicle in the method of the invention. A further aspect of the invention relates to a computer program comprising commands which, when the program is executed by a computer, such as, for example, a control unit of a network server, cause the computer to carry out the steps of the network server in the method of the invention, in particular the steps: receiving a blocking message for a first charging station from a user, determining a current distance between the user and the first charging station, determining a current charging state of the first charging station, determining a current booking entry for the first charging station, and discarding or further processing the blocking message depending on the distance, the charging state, and the booking entry.

The method steps of the method of the invention can be implemented by electrical or electronic parts or components (hardware), by firmware (ASIC), or realized by executing a suitable program (software). The method of the invention is likewise preferably realized or implemented by a combination of hardware, firmware, and/or software. For example, individual components for performing individual method steps are designed as a separately integrated circuit or are arranged on a common integrated circuit. Individual components configured to carry out individual method steps are further preferably arranged on a (flexible) printed circuit carrier (FPCB/PCB), a tape carrier package (TCP), or another substrate.

The individual method steps of the method of the invention can be further designed as one or more processes that run on one or more processors in one or more electronic computing devices and are created when one or more computer programs are executed. In this case, the computing devices are preferably designed to work together with other components, for example, a communication module, and possibly one or more sensors, in order to realize the functionalities described herein. The instructions of the computer programs are preferably stored in a memory, such as, for example, a RAM element. However, the computer programs can also be stored in a non-volatile storage medium such as, for example, a CD-ROM, a flash memory, or the like.

It is clear further to a skilled artisan that the functionalities of multiple computers (data processing devices) can be combined or combined in a single device or that the functionality of a specific data processing device can be distributed over a plurality of devices in order to execute the steps of the method of the invention without deviating from the method of the invention.

The various embodiments of the invention mentioned in this application can be advantageously combined with one another, unless stated otherwise in the individual case.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a system of the invention comprising a vehicle of the invention and a network server of the invention according to one embodiment; and

FIG. 2 shows a flow chart of a method of the invention, carried out in the system of the invention, according to an example.

### DETAILED DESCRIPTION

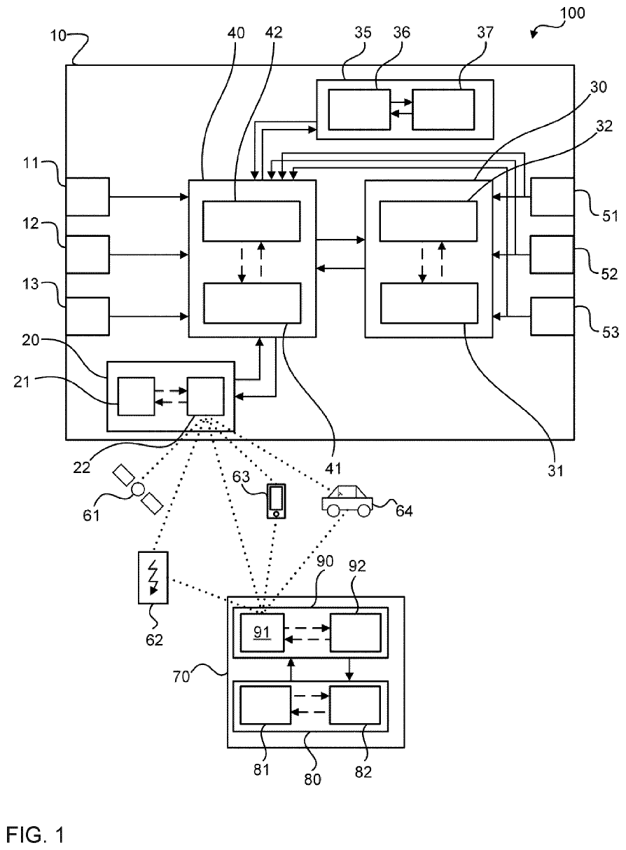

FIG. 1 shows a schematic representation, in particular a block diagram, of an exemplary vehicle 10, in particular a double-track vehicle with an internal combustion, electric, or hybrid engine. Vehicle 10 comprises a multiplicity of first sensors, in particular a first sensor 11, a second sensor 12, and a third sensor 13. First sensors 11, 12, 13 are configured to acquire data about the surroundings of vehicle 10 and comprise, for example, a camera for acquiring an image of the environment immediately surrounding vehicle 10, and distance sensors, such as, for example, ultrasonic sensors or LIDAR, for acquiring distances to objects surrounding vehicle 10. First sensors 11, 12, 13 transmit the surrounding environment signals acquired by them to a first control unit 40 and a driving system 30 of vehicle 10.

Vehicle 10 further has a plurality of second sensors, in particular a fourth sensor 51, a fifth sensor 52, and a sixth sensor 53. Second sensors 51, 52, 53 are sensors for determining status data relating to vehicle 10 itself, such as, for example, current position and movement information of the vehicle. The second sensors are consequently, for example, speed sensors, acceleration sensors, inclination sensors, sensors for measuring an immersion depth of a shock absorber, wheel speed sensors, or the like. Second sensors 51, 52, 53 transmit the status signals acquired by them to first control unit 40 of vehicle 10. In addition, second sensors 51, 52, 53 transmit their measurement results directly to a driving system 30 of vehicle 10.

Vehicle 10 further has a first communication module 20 with a memory 21 and one or more transponders or transceivers 22. Transponders 22 are a radio, WLAN, GPS, or Bluetooth transceiver, or the like. Transponder 22 communicates with internal memory 21 of first communication module 20, for example, via a suitable data bus. First communication module 20 also communicates with first control unit 40. In addition, first communication module 20 is configured to communicate with a mobile network server 70, in particular a backend server of an operator of charging stations 62 for electric vehicles or his service partner. First communication module 20 is configured further to communicate with a mobile device 63 and/or a vehicle 64 and with an electrical charging station 62. The communication takes place in particular via a wireless interface, for example, via WLAN, an LTE cellular network, vehicle-to-vehicle communication, and the like.

Vehicle 10 further has driving system 30, which is configured for fully automatic driving operation, in particular for longitudinal and lateral guidance, of vehicle 10. Driving system 30 has a navigation module 32 which is configured to calculate routes between a starting point and a destination point and to determine the maneuvers to be carried out by vehicle 10 along this route. Navigation module 32 is also preferably designed to carry out specific maneuvers of vehicle 10, such as parking and exit maneuvers, for example. In addition, driving system 30 comprises an internal memory 31 which communicates with navigation module 32, for example, via a suitable data bus. The functionality of driving system 30 is controlled by control unit 40.

Vehicle 10 further has electrical driving system 35, which has an electrical energy storage device 36 and a charging port 37. Electrical energy storage device 36 can be charged via charging port 37 connected to a charging station 62. The functionality of electrical driving system 35 is controlled by control unit 40.

Vehicle 10 further has a first control unit 40, which is configured to carry out the steps of vehicle 10 in the method of the invention. In this regard, control unit 40 carries out the steps itself or controls the other components of vehicle 10 accordingly. For this purpose, first control unit 40 has an internal memory 41 and a CPU 42, which communicate with one another, for example, via a suitable data bus. In addition, first control unit 40 is in communication with at least first sensors 11, 12, 13, second sensors 51, 52, 53, first communication module 20, and driving system 30, for example, via one or more respective CAN connections, one or more respective SPI connections, or other suitable data connections.

Network server 70 has a second control unit 80, which is configured to carry out the steps of network server 70 in the method of the invention. For this purpose, second control unit 80 has an internal memory 81 and a CPU 82, which communicate with one another, for example, via a suitable data bus. Network server 70 further has a second communication module 90. Second communication module 90 has a memory 92 and one or more transponders or transceivers 91. Transponders 91 are a radio, WLAN, GPS, or Bluetooth transceiver, or the like. Transponder 91 communicates with internal memory 92 of second communication module 90, for example, via a suitable data bus. Second communication module 90 is preferably configured to communicate via an LTE cellular network.

Charging station 62 and mobile device 63 also each have a third or fourth communication module and a third or fourth control unit. Charging station 62 further has the capability for charging battery system 36 of an electric vehicle 10, in particular a charging connector for connecting to a charging port 37 of electric driving system 35. Charging station 62 is preferably connected to an energy source or an energy storage device, preferably to a power grid.

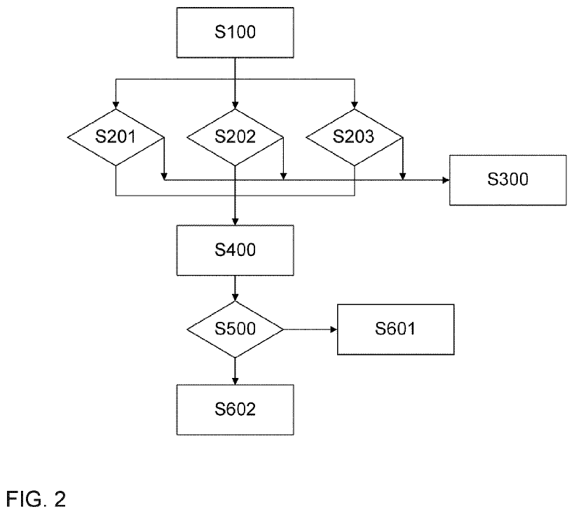

FIG. 2 shows a schematic flow chart of a method of the invention, carried out in system 100 of the invention, according to one embodiment.

In a first step S100, network server 70 receives a blocking message for a specific first charging station 62 from mobile device 63 or vehicle 64. The blocking message contains identification information of mobile device 63 or of vehicle 64, identification information of first charging station 62, and a time stamp.

In response to the receipt of the blocking message, the network server carries out a plurality of checks in step S200 as to whether access to charging station 62 is actually limited or whether it is an incorrect blocking message.

In particular, network server 70 in step S201 checks whether a current distance between mobile device 63 or vehicle 64 and first charging station 62 falls below a predetermined limit value. To this end, network server 70 receives a current position from mobile device 63 or vehicle 64 and calculates the distance to a position of first charging station 62 stored in network server 70. If the distance falls below the predetermined distance, it is assumed that the user is far away from charging station 62 and thus cannot assess a blocking of charging station 62. The method thus proceeds to step S300, in which the blocking message is discarded. If the predetermined distance is exceeded, the method proceeds to step S400.

Further, in step S202, network server 70 checks whether a current charging state of first charging station 62 indicates a charging process of a second vehicle at first charging station 62. For this purpose, it is checked whether a connector of the charging station is connected to a charging port of the second vehicle and, if necessary, whether the second vehicle is drawing power. If the connector is not plugged into the second vehicle or is plugged in without power being drawn, it is assumed that first charging station 62 may be blocked, possibly by the person previously charging, and the method continues to step S400. However, if the connector is plugged in and the second vehicle is drawing power from first charging station 62, first charging station 62 is occupied but not blocked. In this case, the blocking message is discarded in step S300.

Finally, in step S203, network server 70 checks whether there is currently any booking entry at all for a user connected to mobile device 63 or vehicle 64. The current time is determined on the basis of the time stamp of the blocking message and compared with entries in a booking system located on network server 70. If there is no current booking entry for the user, he is not authorized to submit a blocking message and this is therefore discarded in step S300. However, if there is a current booking entry for the user, the method proceeds to step S400.

The blocking message is processed further in S400. For this purpose, the blocking message is completely transmitted from an input memory 92 of second communication module 90 of network server 70 to a control unit 80 of the network server. Further, a time counter (timer) is started by control unit 80, the length of which corresponds to the booking entry determined for the user and the time stamp. In other words, the time for which the user had booked first charging station 62 is counted down.

While the time counter is running, it is checked further in step S500 whether the user, therefore, a vehicle 64 linked to him, starts a charging process at first charging station 62 or whether the blocking continues for the entire duration of the booking entry. If the blocking does not last for the entire booked duration, but a charging process is started during the duration of the original booking entry, the blocking is removed and the user has a claim for a partial reimbursement of a booking fee in step S601. The proportion of the reimbursement is preferably determined by the ratio of the charging time actually used by the user to the time originally booked. In step S601 the user is not entitled to a full refund.

If, in contrast, it is determined in step S500 that the blocking of first charging station 62 continues for the entire duration of the booking entry, in step 602 the user is entitled to a full reimbursement of a booking fee. To this end, an entry in the booking system of charging station 62 is modified and/or a corresponding message is transmitted from network server 70 to a payment service provider. If the blocking was caused by the user who was previously charging at first charging station 62, therefore, a person known to network server 70 via ID information, a penalty fee may be imposed on this user. For this purpose, an entry in the booking system can also be modified and a payment service provider can be notified.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a booking system of a charging station for an electric vehicle, the method comprising:
receiving a blocking message for a first charging station from a user;
determining a current distance between the user and the first charging station;
determining a current charging state of the first charging station;
determining a current booking entry of the first charging station; and
discarding or further processing the blocking message depending on the distance, the charging state, and the booking entry.

2. The method according to claim 1, wherein the blockage message is received from a vehicle or from a mobile device of the user.

3. The method according to claim 2, further comprising:
receiving a current position of the vehicle or mobile device; and
determining the distance based on the received position and a location of the first charging station.

4. The method according to claim 1, wherein the blocking message is received from a vehicle, and further comprising:
receiving the distance between the vehicle and the charging station, wherein the distance from at least one first sensor of the vehicle is determined.

5. The method according to claim 1, wherein the charging state is determined based on a connector status or a power delivery of the charging column.

6. The method according to claim 1, wherein the blocking message is discarded if the determined distance exceeds a predetermined distance, if the determined charging state indicates the charging of a second vehicle, or if the determined booking entry does not correspond to the user.

7. The method according to claim 1, wherein the blocking message is processed further if the determined distance falls below a predetermined distance, if the determined charging state does not indicate the charging of a second vehicle, and if the determined booking entry corresponds to the user.

8. The method according to claim 7, further comprising:
determining a charging process of the user within a time window corresponding to the determined booking entry; and
further processing the blocking message in the booking system for a partial reimbursement of booking fees.

9. The method according to claim 7, further comprising:
determining no charging process by the user in a time window corresponding to the determined booking entry; and
further processing the blocking message in the booking system for a full reimbursement of booking fees.

10. A network server comprising:
a second communication module configured for data communication with a vehicle and a charging station; and
a second control unit, wherein the second control unit is configured:
to control the second communication module to receive a blocking message for a first charging station from a user;
to determine a current distance between the user and the first charging station, a current charging state of the first charging station, and a current booking entry of the first charging station; and
to discard or to further process the received blocking message depending on the distance, the charging state, and the booking entry.
